(19) United States
(12) Patent Application Publication
(10) Pub. No.: US 2026/0192596 A1
(43) Pub. Date: Jul. 9, 2026

(54) Wheel for a Motor Vehicle

(71) Applicant: Mercedes-Benz Group AG, Stuttgart (DE)

(72) Inventor: Frank HUMMEL, Eningen (DE)

(21) Appl. No.: 18/863,906

(22) PCT Filed: May 9, 2023
(86) PCT No.: PCT/EP2023/062289

§ 371 Date: Nov. 7, 2024

(30) Foreign Application Priority Data
May 10, 2022 (DE) 10 2022 001 651.6

(51) Int. Cl. B60B 7/00; B60B 3/10; B60B 7/04; B60B 7/08

(52) U.S. Cl. CPC B60B 7/0066; B60B 3/10; B60B 7/04; B60B 7/08; B60B 2900/1216; B60B 2900/513

(57) ABSTRACT

A wheel for a motor vehicle includes a wheel hub disposed centrally in the wheel and having wheel spokes, a wheel rim disposed radially in a circumferential region of the wheel, a wheel disc disposed in an intermediate region between the wheel hub and the wheel rim, and an actuator integrated in the wheel hub. The wheel disc is divided into at least two movable disc segments separated from one another by a respective separating gap. The at least two movable disc segments are tiltable and are connected to the wheel spokes via movable bearing points. An angular position of the at least two movable disc segments is changeable by tilting the at least two movable disc segments about the movable bearing points on the wheel spokes.

### BACKGROUND AND SUMMARY OF THE INVENTION

The invention relates to a wheel for a motor vehicle.

A rim for a wheel of a motor vehicle having closable ventilation openings is known from DE 10 2008 007 690A1 . An actuating device is provided for opening and closing these ventilation openings, and the ventilation openings are designed for a flow to pass through in an axial direction towards the wheel axle when they are in the open state.

DE 10 2013 114 476 A1 describes a closure system for vehicle wheel openings, in which the wheel openings can be selectively closed by means of two pivotable cover panels.

Furthermore, DE 10 2017 204 656 A1 discloses a rim arrangement for a vehicle wheel, in which arrangement a rotatable cover disc can be rotated into two different positions by means of an actuator on the rim.

Generic document DE 10 2021 004 881 A1 discloses a wheel for a car, comprising a wheel unit which has a central securing region by means of which the wheel can be connected to a wheel hub of the car for conjoint rotation therewith, an outer rim on which a tire can be mounted, and a connecting region which is arranged in the radial direction of the wheel between the securing region and the rim and via which the securing region is connected to the rim. Furthermore provided is an elastically deformable cover element and an actuator which is supported on the wheel unit and by means of which the cover element can be actively elastically deformed relative to the wheel unit and thereby transferred from a first state into a second state, wherein, in one of the states, at least one flowthrough opening through which air can flow is closed by means of the cover element, and in the other state, the flowthrough opening formed between the outer edge of the cover element and the wheel is exposed. The cover element is supported by support elements in the connecting region which has wheel spokes in particular, so that when the actuator is actuated, the inner region of the cover element is pulled in the direction of the wheel hub, so that the outer edge region of the cover element is erected, as it were, as a result of the deformation thereof. The cover element can be designed such that it lies over the entire area of the wheel spokes or in multiple segments between the wheel spokes. Alternatively, multiple independently arranged and secured cover elements can also be provided.

The problem addressed by the present invention is that of specifying a wheel for a motor vehicle of the type mentioned in the introduction, which can be operated simply and reliably in two different operating states.

According to the invention, the wheel disc of the motor vehicle wheel, which consists of a dimensionally stable, temperature-resistant and wear-free material of maximum rigidity and is arranged between the wheel hub and the wheel rim, is divided into two or more movable disc segments of preferably equal size; i.e., the surface of the wheel disc that forms a complete circle is divided into two or more circle segments of preferably equal size. Owing to the choice of material cited for the wheel disc and therefore also for the movable disc segments of the wheel disc, these retain their specified contour even when the motor vehicle is travelling.

The respective disc segments or circle segments of the wheel disc of the wheel of the motor vehicle are each separated from one another by a separating gap.

This separating gap between the disc segments can be filled with a filler layer made from an elastic material, that is an elastic connecting layer, thereby creating a fully closed surface of the wheel disc based on two materials having different material properties.

As an alternative to this, the separating gap between the disc segments of the wheel disc can also be retained, for example for design reasons to make the wheel spokes visible. In this case, therefore, the separating gap between the disc segment is not filled and the wheel disc that is not fully closed consequently only consists of a single, uniform, dimensionally stable material.

Integrated in the wheel hub arranged centrally in the wheel and connected to an axle of the motor vehicle is an actuator, which is connected to all of the movable disc segments of the wheel disc via connecting elements designed in particular as tilting joints or hinge joints. These connecting elements are actuated via the deflection of the, for example electromagnetic, actuator, and as a result the angular positions of all of the movable disc segments are changed simultaneously. The movable disc segments can be tilted, causing an air gap (annular gap) to form between the edge region, adjacent to the wheel rim, of the disc segments and the wheel rim. A convective air flow can get to the rear of the wheel through this this air gap (annular gap). Such a formation of an air gap (annular gap) is adjusted by the described procedure particularly when, in certain driving situations of the motor vehicle, a critical operating temperature is reached at the brakes of the motor vehicles or a critical temperature value on the rear of the wheel is reached.

This air gap (annular gap) can also be realized in different ways depending on the design of the wheel disc and therefore the movable disc segments of the wheel disc.

For example, the disc segments having a flat (planar) contour can be brought into a convex contour or into a concave contour, whereby an air gap is formed between the edge region, adjacent to the wheel rim, of the disc segments and the wheel rim.

Alternatively, the disc segments having a concave contour can be brought into a flat (planar) contour or into a convex contour, whereby an air gap is likewise formed between the edge region, adjacent to the wheel rim, of the disc segments and the wheel rim. Or the disc segments having a convex contour can be brought into a flat (planar) contour or into a concave contour, whereby an air gap is likewise formed between the edge region, adjacent to the wheel rim, of the disc segments and the wheel rim.

The actuator integrated in the wheel hub is controlled wirelessly by a control unit of the motor vehicle by means of a control signal, with a control signal being generated for moving (for disengaging or engaging) the actuator and therefore also for altering the disc segments of the wheel disc in a certain operating state of the motor vehicle, in particular when the brakes of the motor vehicle are in a certain critical operating state. Particularly when a (critical) temperature threshold value is reached in the region of the brakes of the motor vehicle, the actuator is controlled appropriately, this changing the angular position of the disc segments so that an air gap (annular gap) of, for example, 20 mm to 50 mm is produced between the edge region, adjacent to the wheel rim, of the disc segments and the wheel rim at the disc edge of the disc segments of the wheel disc.

In order to tilt the disc segments of the wheel disc, these disc segments are preferably arranged between the wheel spokes by means of movable bearing points, for example by means of elastomeric joints or ball joints, and are connected to the wheel spokes via securing means. When the actuator is deflected, the opening angle of the edge region of the disc segments of the wheel disc can thus assume two different values, one in the closed state of the edge region of the disc segments and the other in the open state of the edge region of the disc segments.

Further advantages, features and details of the invention will emerge from the following description of a preferred exemplary embodiment and with reference to the drawings. The features and feature combinations mentioned above in the description and the features and feature combinations mentioned below in the description of the figures and/or shown alone in the two figures can be used not only in the respectively specified combination, but also in other combinations or in isolation, without departing from the scope of the invention.

### BRIEF DESCRIPTION OF THE DRAWINGS

FIG. 1 a schematic plan view of the wheel of the motor vehicle; and

FIG. 2 a sectional illustration of a portion of the wheel of the motor vehicle, showing the two different operating states of the wheel of the motor vehicle.

### DETAILED DESCRIPTION OF THE DRAWINGS

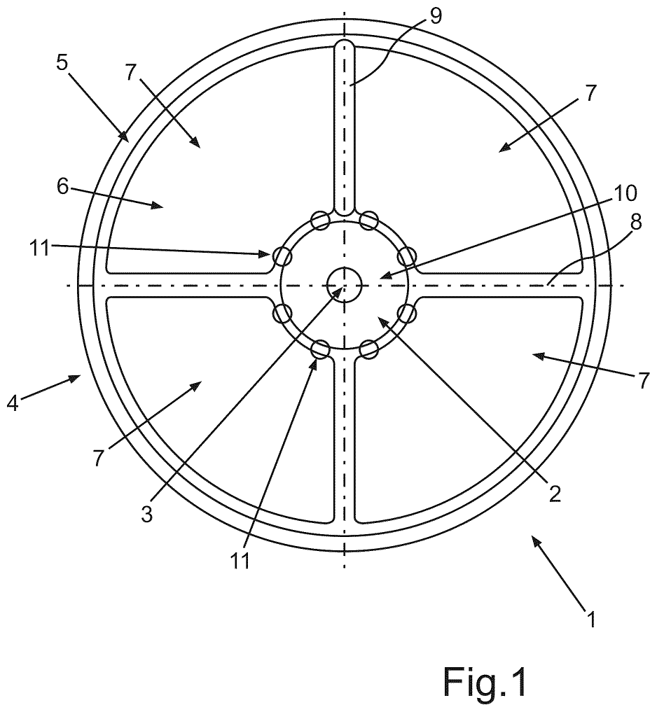

As shown in plan view in FIG. 1, the wheel 1 of a motor vehicle designed, for example, as a fully electric vehicle (BEV) has a wheel hub 2 located centrally in the wheel 1 and connected to an axle of the motor vehicle.

The wheel rim 5 is arranged around the peripheral circumferential region 4 of the wheel 1, and a tire (not shown in FIG. 1) of the motor vehicle can be mounted on the wheel rim and thus on the wheel 1.

Furthermore, located between the wheel hub 2 and the wheel rim 5 of the wheel is the, for example planar, wheel disc 6 that consists of a deformation-resistant material; the wheel disc 6 manufactured, for example, by means of an injection moulding or casting process consists, for example, of a plastic such as a thermoplastic or thermoset or of a light metal alloy such as aluminium or magnesium. According to FIG. 1, this circular wheel disc 6 is divided into, for example, four equally-sized regions as movable disc segments 7 or circle segments, each of which thus takes up approximately one quadrant of the surface of the wheel 1. By dividing the wheel disc 6 into the movable disc segments 7, the disc segments 7 also have the same dimensionally stable material property as the entire wheel disc 6.

The separating gap 8 between adjacent disc segments 7 is filled, for example, with an elastic connecting layer, that is a filler layer 9 made of an elastic material, for example with an elastomer such as polytetrafluoroethylene (PTFE) or silicone or with a rubbery material. As a result, despite the wheel disc 6 being segmented into multiple disc segments 7, the wheel 1 is covered continuously over the entire area thereof. The wheel disc 6 consequently consists of regions with different materials properties, namely the regions of the disc segments 7 with a dimensionally stable material and the regions of the filler layer 9 with an elastic material.

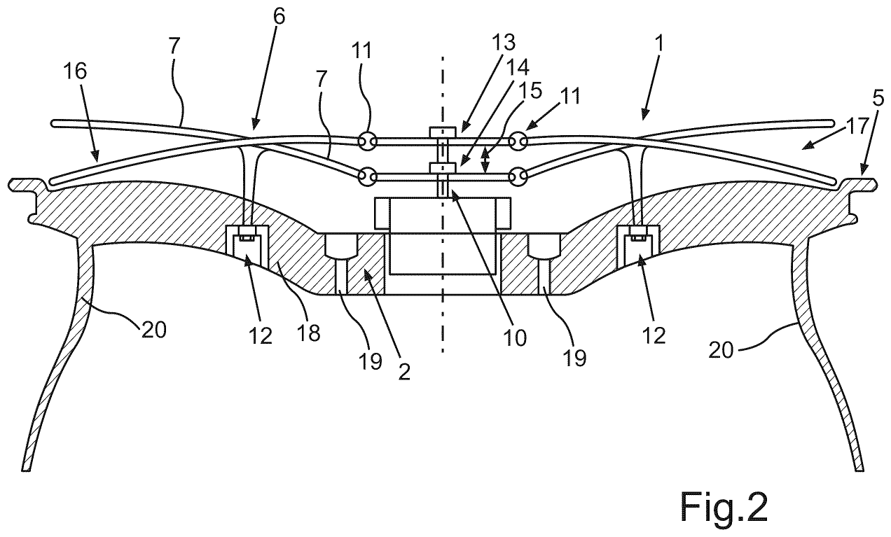

In addition, an electromagnetic actuator 10 having a cover cap 3 is integrated in the wheel hub 2 (also see FIG. 2 in this regard) and is connected via connecting elements 11 to all four disc segments 7 of the wheel disc 6 and can specify the two different angular positions of the disc segments 7 depending on the respective operating state. These two different operating states or angular positions of the movable disc segments 7 of the wheel disc 6 can be seen from the sectional illustration of FIG. 2, showing the upper part of the wheel 1.

The electromagnetic actuator 10 integrated in the wheel hub 2 is connected to the disc segments 7 of the wheel disc 6 via connecting elements 11 designed, for example, as hinge joints, wherein the movable disc segments 7 of the wheel disc 6 are in turn attached to the wheel spokes 18 via movable bearing points, for example by means of ball joints 12 via securing elements designed, for example, as flange elements.

Furthermore, according to FIG. 2, drill holes 19 for wheel screws are provided in the wheel spokes 18 and the region of the wheel rim 5 located in center of the rim flanges (of the outer flange of the wheel 1) is provided as a rim well 20.

In one operating state, i.e., in the normal driving mode of the motor vehicle designed, for example, as a fully electric vehicle (BEV), the electromagnetic actuator 8 is in the disengaged position 13 for example and the disc segments 7 of the wheel disc 6 therefore lie flat, in particular also in their edge region 16, that is the disc segments 7 of the wheel disc 6 form a fully closed cover of the wheel 1. As a result, the drag coefficient (Cd) of the wheel 1 and thus of the motor vehicle is not negatively affected.

In the other operating state, that is in the case of large braking deceleration of the motor vehicle designed, for example, as a fully electric vehicle (BEV) or if the brake discs of the motor vehicle heat up significantly when the motor vehicle is in drive mode, the electromagnetic actuator 10 is moved into the engaged position 14. The travel path 15 of the electromagnetic actuator 10 between the disengaged position 13 and the engaged position 14 is approximately 40 mm, for example. When the electromagnetic actuator 10 is moved into the engaged position 14, the disc segments 7 of the wheel disc 6 are also tilted by a certain angle of, for example 10°, via the connecting elements 11, so that an air gap 17 (annular gap) is formed between the edge region 16, adjacent to the wheel rim 5, of the disc segments 7 and the wheel rim 5. For example, this forms an air gap 17 (annular gap) between the edge region 16, adjacent to the wheel rim 5, of the disc segments 7 and the wheel rim 5 of approximately 30 mm, which lets an air flow and therefore a convective flow get to the rear of the wheel, thereby ensuring effective cooling of brake discs of the motor vehicle that are located there.

The electromagnetic actuator 10 is controlled, and consequently the disc segments 7 of the wheel disc 6 are adjusted (tilted), via a control unit of the motor vehicle, which supplies corresponding control signals to the electromagnetic actuator 10 wirelessly.

In particular if, when the motor vehicle is in drive mode, a specified threshold value for the operating temperature of the brakes of the motor vehicle is reached or a specified threshold value for the temperature on the rear of the wheel 1 is reached, the control signal is issued to engage the electromagnetic actuator 10, thereby forming the air gap 17 (annular gap).

If a further value for the operating temperature of the brakes of the motor vehicle drops below the threshold again or a further value for the temperature on the rear of the wheel 1 drops below the threshold again, the control signal is issued to disengage the electromagnetic actuator 10 into the disengaged position 13, thereby closing the air gap 17 (annular gap) again, so that a fully closed cover of the wheel 1 with the disc segments 7 and the filler layers 9 is formed, which in turn positively affects the drag coefficient (Cd).

1-10. (canceled)

11. A wheel (1) for a motor vehicle, comprising:
a wheel hub (2) disposed centrally in the wheel (1) and having wheel spokes (18);
a wheel rim (5) disposed radially in a circumferential region (4) of the wheel (1);
a wheel disc (6) disposed in an intermediate region between the wheel hub (2) and the wheel rim (5); and
an actuator (10) integrated in the wheel hub (2);
wherein the wheel disc (6) is divided into at least two movable disc segments (7) separated from one another by a respective separating gap (8) and wherein the actuator (10) is connected to the at least two movable disc segments (7) via connecting elements (11);
wherein the at least two movable disc segments (7) are tiltable and are connected to the wheel spokes (18) via movable bearing points;
wherein an angular position of the at least two movable disc segments (7) is changeable by tilting the at least two movable disc segments (7) about the movable bearing points on the wheel spokes (18).

12. The wheel (1) according to claim 11, wherein when the at least two movable disc segments (7) are tilted, an air gap (17) is formed between an edge region (16), adjacent to the wheel rim (5), of the at least two movable disc segments (7) and the wheel rim (5).

13. The wheel (1) according to claim 11, wherein the connecting elements (11) are tilting joints or hinge joints.

14. The wheel (1) according to claim 11, wherein the respective separating gap (8) is filled with a filler layer (9) made from an elastic material.

15. The wheel (1) according to claim 11, wherein the at least two movable disc segments (7) consist of a dimensionally stable material.

16. The wheel (1) according to claim 12, wherein the at least two movable disc segments (7) have a flat contour and, when tilted, are brought into a convex contour or a concave contour to form the air gap (17)

17. The wheel (1) according to claim 12, wherein the at least two movable disc segments (7) have a concave contour and, when tilted, are brought into a flat contour or a convex contour to form the air gap (17).

18. The wheel (1) according to claim 12, wherein the at least two movable disc segments (7) have a convex contour and, when tilted, are brought into a flat contour or a concave contour to form the air gap (17).

19. The wheel (1) according to claim 11, wherein the actuator (10) is controllable wirelessly via a control unit of the motor vehicle by a control signal.

20. The wheel according to claim 11, wherein the movable bearing points are elastomeric joints or ball joints.
